(19) United States
(12) Patent Application Publication
(10) Pub. No.: US 2016/0348969 A1
(43) Pub. Date: Dec. 1, 2016

(54) HEAT TREATMENT DEVICE

(71) Applicants: IHI Corporation, Tokyo (JP); IHI Machinery and Furnace Co., Ltd., Tokyo (JP)

(72) Inventors: Kazuhiko KATSUMATA, Inuyama-shi (JP); Kaoru ISOMOTO, Tokyo (JP); Takahiro NAGATA, Kamo-gun (JP); Akira NAKAYAMA, Hikari-shi (JP); Yuusuke SHIMIZU, Gifu-shi (JP); Gen NISHITANI, Kakamigahara-shi (JP)

(73) Assignees: IHI Corporation, Tokyo (JP); IHI Machinery and Furnace Co., Ltd., Tokyo (JP)

(21) Appl. No.: 15/234,518

(22) Filed: Aug. 11, 2016

Related U.S. Application Data
(63) Continuation of application No. PCT/JP2015/061090, filed on Apr. 9, 2015.

(30) Foreign Application Priority Data
Apr. 24, 2014 (JP) 2014-090569

(51) Int. Cl. F27B 5/16; F27B 5/14; C21D 1/06; F27D 7/02; C23C 8/20; C21D 1/773

(52) U.S. Cl. CPC F27B 5/16; C23C 8/20; C21D 1/773; C21D 1/06; F27D 7/02; F27B 5/14

(57) ABSTRACT

A heat treatment device which performs vacuum carburizing treatment by heating a workpiece is presented. The heat treatment device includes: a heater chamber in which a heater is provided; a heat treatment chamber in which the workpiece is heated and vacuum carburizing treatment is performed on the workpiece and is disposed so as to be adjacent to the heater chamber in the heat treatment device; and a muffle plate which partitions a portion between the heater chamber and the heat treatment chamber. A gas introduction portion through which burnout gas is introduced is independently provided in each of the heater chamber and the heat treatment chamber.

### TECHNICAL FIELD

Embodiments described herein relates to a heat treatment device.

This application is a Continuation of International Application No. PCT/JP2015/061090, filed on Apr. 9, 2015, claiming priority based on Japanese Patent Application No. 2014-090569, filed on Apr. 24, 2014, the content of which is incorporated herein by reference in their entirety.

### BACKGROUND ART

As a heat treatment device which heats a metal material which is a workpiece, a vacuum carburizing furnace is known (for example, refer to Patent Document 1).

The vacuum carburizing furnace is a device which performs a vacuum carburizing treatment under a high temperature and a reduced pressure using hydrocarbon-based gas, and in the vacuum carburizing treatment, the hydrocarbon-based gas is decomposed into carbon and hydrogen and the carbon reacts on a surface of steel so as to generate carburization.

In the vacuum carburizing treatment, not only does the hydrocarbon-based gas decompose into carbon and hydrogen at a high temperature and under a reduced pressure, but the hydrocarbon-based gas also generates a polymerization reaction, and a polymer is likely to be generated. In addition, the decomposed carbon may turn into soot. Accordingly, if products such as the polymer or the soot are attached to and accumulated on the inside of a furnace, particularly, a wall surface of the furnace, a heat insulating material configuring a wall surface is impregnated with the products and a heating insulating function decreases.

If the heat insulating function decreases, excessive energy, excessive time, or the like is needed.

Accordingly, in the related art, in order to prevent the decrease of the heat insulating function, an operation referred to as burnout which introduces air into the furnace so as to combust products such as the soot is performed.

Patent Document 2 discloses a production method of aluminum nitride, in which a heater is provided between a furnace shell and a heat-resistant muffle (paragraph [0135] and FIG. 2), factory air for cooling is supplied to a gap between the furnace shell and the heat-resistant muffle (paragraph [0137]), and nitrogen gas and argon gas are supplied into the heat-resistant muffle (paragraph [0138]).

Patent Document 3 discloses a vacuum carburizing furnace and a burnout method of a vacuum carburizing furnace.

Patent Document 4 discloses a blast vacuum furnace, in which heating elements are disposed at equal intervals around a muffle tube which forms a cylindrical chamber inside of the muffle tube.

Patent Document 5 discloses a vertical burning furnace, in which a gas exhaust pipe is connected to each of predetermined positions of a furnace body which are radially disposed with respect to a center axis of the furnace body, and thus, a flow of exhaust gas can be uniformized in the heater chamber (paragraph [0016]).

### CITATION LIST

### Patent Document

[Patent Document 1] Japanese Unexamined Patent Application, First Publication No. 2006-112770

[Patent Document 2] Japanese Unexamined Patent Application, First Publication No. 2003-212521

[Patent Document 3] Japanese Unexamined Patent Application, First Publication No. 2007-131936

[Patent Document 4] Japanese Unexamined Patent Application, First Publication No. S63-127072

[Patent Document 5] Japanese Unexamined Patent Application, First Publication No. H07-091847

### SUMMARY

### Technical Problem

In the vacuum carburizing furnace of the related art such as the vacuum carburizing furnace of Patent Document 1, in general, the heater is directly disposed inside the heat treatment chamber (inside the furnace). Accordingly, burnout is simultaneously performed in the interior of the entire furnace.

However, if burnout is simultaneously performed in the interior of the entire furnace, since it is determined that soot or the like is attached to the interior of the entire furnace even during a performance period of burnout, it is difficult to perform burnout at an appropriate period. Accordingly, it is difficult to stably perform heat treatment on a workpiece and stabilize treatment quality.

The present disclosure is made in consideration with the above-described circumstances, and an object thereof is to provide a heat treatment device capable of stably performing heat treatment and stabilizing treatment quality by appropriately performing burnout.

### Solution to Problem

According to a first aspect of the present disclosure, a heat treatment device which performs vacuum carburizing treatment by heating a workpiece includes: a heater chamber in which a heater is provided; a heat treatment chamber in which the workpiece is heated and vacuum carburizing treatment is performed on the workpiece and which is disposed adjacent to the heat chamber in the heat treatment device, a muffle plate which partitions a portion between the heater chamber and the heat treatment chamber; and a gas introduction portion through which burnout gas is introduced and which is independently provided in each of the heater chamber and the heat treatment chamber.

According to a second aspect of the present disclosure, in the first aspect, a double exhaust pipe is provided in the heat treatment device, and the double exhaust pipe includes a first exhaust pipe which communicates with the heater chamber, and a second exhaust pipe which communicates with the heat treatment chamber and is inserted into the first exhaust pipe.

According to a third aspect of the present disclosure, in the first or second aspect, the heater chamber is disposed outside the heat treatment chamber and surrounds the heat treatment chamber.

According to a fourth aspect of the present disclosure, in the third aspect, the heat treatment chamber is formed in a circular shape in a plan view, and a plurality of heaters are radially disposed in the heater chamber with respect to the center of the heat treatment chamber.

According to a fifth aspect of the present disclosure, in the third or fourth aspect, a plurality of heater chamber gas introduction portions, through which the burnout gas is introduced into the heater chamber, are radially provided with respect to the heater chamber.

According to the heat treatment device of the present disclosure, since the heater chamber and the heat treatment chamber are disposed so as to be adjacent to each other in the heat treatment device, and the gas introduction portion through which the burnout gas is introduced is independently provided in each of the heater chamber and the heat treatment chamber, it is possible to independently perform burnout in each of the heater chamber and the heat treatment chamber. Accordingly, since burnout can be appropriately performed in each chamber, it is possible to stably perform heat treatment on a workpiece, and it is possible to stabilize treatment quality.

### BRIEF DESCRIPTION OF DRAWINGS

FIG. 1 is a longitudinal sectional view showing a schematic configuration of an embodiment of a heat treatment device of the present disclosure.

FIG. 2 is a view taken along line A-A of FIG. 1.

FIG. 3 is a view taken along line B-B of FIG. 1.

### DESCRIPTION OF EMBODIMENTS

Hereinafter, a heat treatment device of the present disclosure will be described in detail with reference to the drawings. In addition, in the following drawings, the scale of each member is appropriately changed such that the size of each member can be recognized.

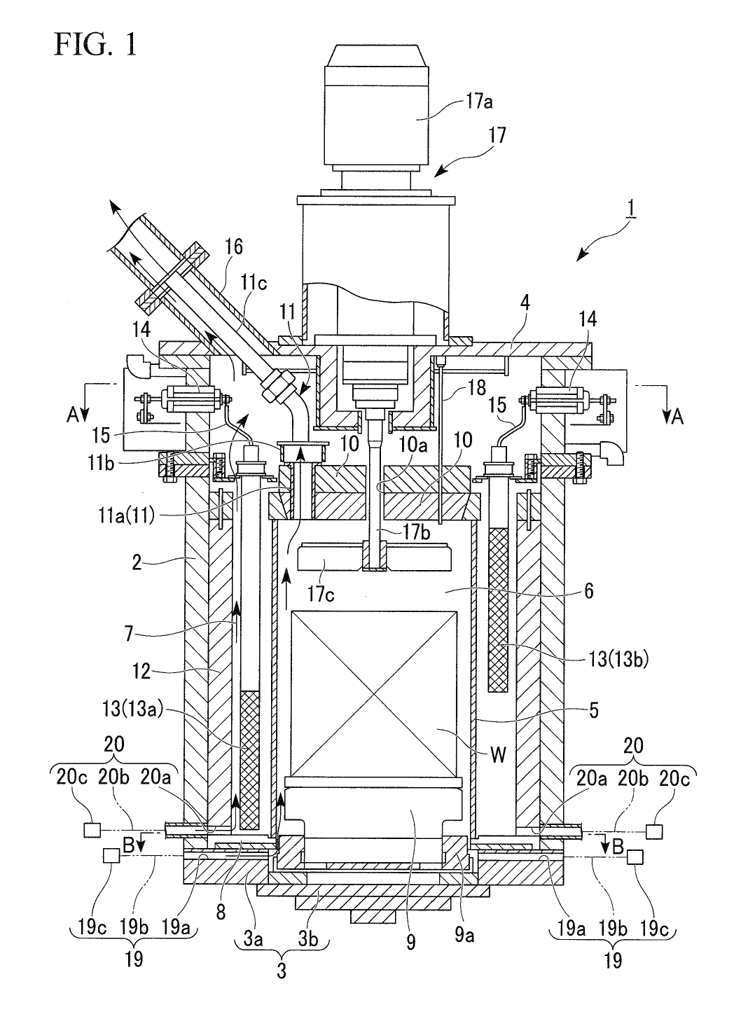

FIG. 1 is a longitudinal sectional view showing a schematic configuration of an embodiment of the heat treatment device of the present disclosure, and a reference numeral 1 in FIG. 1 indicates the heat treatment device. The heat treatment device 1 is a device which functions as a vacuum carburizing furnace which heats a workpiece W and performs vacuum carburizing treatment.

The heat treatment device 1 is formed in an approximately cylindrical shape, and is a vertical type device in which the center axis thereof is disposed in a vertical direction. In the heat treatment device 1, a bottom portion 3 and a cover portion 4 are provided with respect to a side wall portion 2 having an approximately cylindrical shape, and a closed space is formed inside the heat treatment device 1. The closed space, that is, the inner portion of the heat treatment device 1 is divided into a heat treatment chamber 6 and a heater chamber 7 by a partition wall 5 including a muffle plate which is foamed in a cylindrical shape. That is, the heat treatment chamber 6 and the heater chamber 7 are disposed so as to be adjacent to each other via the partition wall 5, and are partitioned by the partition wall 5.

Here, the approximately circular shape includes a case where the section is not limited to a perfect circle and is an elliptical shape or a polygonal shape.

The bottom portion 3 is configured so as to include an annular bottom portion frame body 3a, and a bottom portion main body 3b which is detachably attached to through holes of the bottom portion frame body 3a so as to airtightly close the through holes. A lower part heat insulating material 8 having an annular plate shape is provided on the bottom portion frame body 3a, and the partition wall 5 is disposed in a state where the partition wall 5 stands on the inner peripheral edge portion of the lower part heat insulating material 8. For example, the lower part heat insulating material 8 is formed by laminating a heat insulating material formed of a ceramic fiber board or the like and a ceramic board.

The bottom portion main body 3b is detachably attached to the bottom portion frame body 3a by screws or the like, and is formed and disposed so as to cover the lower opening of the partition wall 5. According to this configuration, the bottom portion main body 3b functions as an opening and closing member for inserting and removing a workpieces W with respect to the heat treatment chamber 6 which is formed in the partition wall 5. That is, a furnace bottom 9 is disposed on the bottom portion main body 3b, and the workpiece W such as a steel material is placed on the furnace bottom 9. In addition, a heat insulating material 9a having an approximately cylindrical shape is disposed outside the furnace bottom 9 so as to surround the lower end portion of the furnace bottom 9.

The partition wall 5 is disposed such that the center axis thereof approximately coincides with the center axis of the side wall portion 2, and is formed of a muffle plate, that is, a refractory having improved thermal conductivity. Two layers of upper part heat insulating materials 10 are disposed so as to be laminated on the upper end portion of the partition wall 5, and the upper opening of the partition wall 5 is closed. In addition, a plurality of through holes are formed in the upper part heat insulating materials 10, and a second exhaust pipe 11 is inserted into one of the plurality of through holes. The second exhaust pipe 11 is disposed so as to be connected with the inside of the partition wall 5, that is, the heat treatment chamber 6, and gas in the heat treatment chamber 6 is exhausted to the outside of the heat treatment device 1 through the second exhaust pipe 11 during heat treatment (during carburizing treatment) or during burnout described below.

In the present embodiment, the second exhaust pipe 11 is formed so as to include a lower pipe 11a which is inserted into the through holes (not shown) of the upper part heat insulating materials 10, a bottomed cylindrical intermediate pipe 11b which is disposed so as to cover the upper opening of the lower pipe 11a, and an upper pipe 11c which is inserted into the intermediate pipe 11b, is integrally formed with the intermediate pipe 11b, and includes a distal side of the upper pipe 11c which is inserted into a first exhaust pipe 16 described below. The upper pipe 11c is formed so as to be bent such that the distal side thereof is inserted into the first exhaust pipe 16.

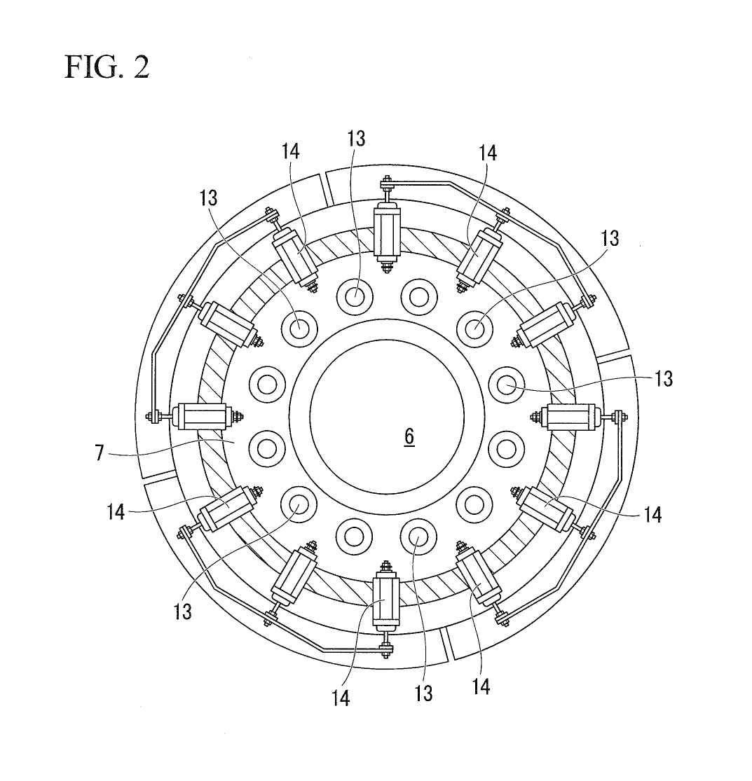

The heater chamber 7 is formed between the side wall portion 2 and the partition wall 5, that is, immediately on the bottom portion frame body 3a. The heater chamber 7 is formed in an annular shape in a plan view so as to surround the heat treatment chamber 6 inside the partition wall 5, a cylindrical side part heat insulating material 12 is disposed on the side wall portion 2 side of the heater chamber 7, and a plurality of heaters 13 are disposed between the side part heat insulating material 12 and the partition wall 5. In the present embodiment, as shown in FIG. 2 which is a view taken along line A-A of FIG. 1, the heaters 13 are radially disposed with respect to the center of the heat treatment chamber 6.

That is, as shown in FIG. 2, in the present embodiment, 12 heaters 13 are radially disposed with respect to the center of the heat treatment chamber 6. The 12 heaters 13 are disposed at equal intervals in a circumferential direction of the heater chamber 7. However, in the present embodiment, as shown in FIG. 1, each of the heaters 13 is formed of a lower heater 13a which mainly heats a lower half portion of the heat treatment chamber 6 inside the partition wall 5, and an upper heater 13b which heats an upper half portion of the heat treatment chamber 6. In addition, since the lower heaters 13a and the upper heaters 13b are alternately disposed in the circumferential direction, not only the circumferential direction of the heat treatment chamber 6 but also the axial direction (upward-downward direction) of the heat treatment chamber 6 is uniformly heated.

In addition, an electrode 14 is correspondingly connected to each of the heaters 13, and power is supplied to the heaters 13 via the electrodes 14. As shown in FIG. 1, each of the electrodes 14 is disposed above the heater 13, that is, on the side wall portion 2 on the upper portion of the heater chamber 7, and a portion between the electrode 14 and the heater 13 is connected by a heat-resistant electric wire 15.

The inner portion of the side wall portion 2 above heater chamber 7 is an upper space which communicates with the heater chamber 7. In addition, the lower end side of the upper pipe 11c of the second exhaust pipe 11 is disposed in the upper space. The cover portion 4 which covers the upper opening of the side wall portion 2 is provided on the upper space. The cover portion 4 is detachably screwed to a flange (not shown) which is formed on the upper opening of the side wall portion 2, and the first exhaust pipe 16 is provided on the outer peripheral side of the cover portion 4.

The first exhaust pipe 16 is disposed diagonally upward with respect to the cover portion 4, the proximal side of the first exhaust pipe 16 is disposed so as to communicate with the upper space, and the distal side thereof is connected to a vacuum pump (not shown). In addition, in the first exhaust pipe 16, the distal side of the second exhaust pipe 11 is inserted into the intermediate portion of the first exhaust pipe 16. Since an outer diameter of the upper pipe 11c of the second exhaust pipe 11 is smaller enough than an inner diameter of the first exhaust pipe 16, the flow path of the first exhaust pipe 16 is not blocked by the second exhaust pipe 11, and the first exhaust pipe 16 can obtain a flow path having a sufficiently large opening cross section.

According to the above-described configuration, the first exhaust pipe 16 and the second exhaust pipe 11 which is inserted into the first exhaust pipe 16 configure a double exhaust pipe according to the present disclosure. In addition, the first exhaust pipe 16 and the second exhaust pipe 11 configured as described above are connected to the vacuum pump. Accordingly, the inner portion of the heater chamber 7 which communicates with the upper space is forcedly exhausted via the first exhaust pipe 16 by the vacuum pump, and the inner portion of the heat treatment chamber 6 is forcedly exhausted via the second exhaust pipe 11 by the vacuum pump.

In addition, a stirrer 17 is provided at the center portion of the cover portion 4. The stirrer 17 is configured so as to include a driving portion 17a which is configured of a motor or the like, and a stirring blade 17c which is attached to the lower portion of the driving portion 17a via a drive shaft 17b. The drive shaft 17b is disposed so as to penetrate a through hole 10a which is formed in the upper part heat insulating material 10, the stirring blade 17c is attached to the lower end portion of the drive shaft 17b, and the stirring blade 17c is disposed on the upper end side inside the heat treatment chamber 6, that is, the upper part heat insulating material 10 side in the heat treatment chamber 6. According to the configuration, the stirrer 17 stirs the inner portion of the heat treatment chamber 6 by rotation of the stirring blade 17c, and temperature or gas concentration inside the heat treatment chamber 6 is uniformized.

In addition, a gas supply pipe 18 is connected to the cover portion 4. The gas supply pipe 18 is connected to a supply source (not shown) of hydrocarbon-based gas such as acetylene-based gas via a pipe (not shown) outside the cover portion 4, the distal side (lower end side) of the gas supply pipe 18 passes through a through hole (not shown) of the upper part heat insulating material 10 via the upper space, and the distal portion thereof is disposed on the upper part heat insulating material 10 side inside the heat treatment chamber 6. In the present embodiment, a gas supply port (not shown) of the gas supply pipe 18 is disposed in the vicinity of the lower surface of the upper part heat insulating material 10. Accordingly, hydrocarbon-based gas supplied from the gas supply pipe 18 into the heat treatment chamber 6 is diffused by the stirring blade 17c which is disposed on the upper part heat insulating material 10 side in the heat treatment chamber 6, and forms a uniform gas atmosphere in the heat treatment chamber 6.

In the heat treatment device 1 having the above-described configuration, a plurality of heat treatment chamber gas introduction portions 19 through which burnout air (gas) is introduced into the heat treatment chamber 6 are provided on the bottom portion 3.

Each of the heat treatment chamber gas introduction portions 19 is configured of a through hole 19a which is formed on the upper portion of the bottom portion frame body 3a, a pipe 19b which is connected to the through hole 19a, and an air source 19c (gas source) which supplies air (gas) into the through hole 19a via the pipe 19b. In addition, the burnout gas is not limited to air, and for example, various gases can be used as long as it is gas which includes oxygen such as oxygen gas or compressed air.

One end side of the through hole 19a opens to the side peripheral surface of the bottom portion frame body 3a, and the other end side thereof opens so as to face the side surface of the heat insulating material 9a of the furnace bottom 9 which is disposed on the bottom portion main body 3b. The through holes 19a are radially formed with respect to the center of the heat treatment chamber 6 surrounded by the partition wall 5, at a plurality of locations, for example, four locations. In addition, the through holes 19a are disposed at equal intervals in the circumferential direction of the bottom portion 3.

The pipe 19b is connected to each of the through holes 19a, the air source 19c is connected to the pipe 19b, and thus, the heat treatment chamber gas introduction portion 19 is configured. In addition, a control unit (not shown) which adjusts the amount of the supplied air is provided in the air source 19c. According to this configuration, the air (gas) supplied from the air source 19c is introduced into the heat treatment chamber 6 via the pipe 19b and the through hole 19a. That is, the air introduced from the opening of the other end side of the through hole 19a is introduced into the partition wall 5, that is, into the heat treatment chamber 6 through a portion between the side surface of the heat insulating material 9a of the furnace bottom 9 and the inner peripheral surface of the lower part heat insulating material 8. In addition, in the heat insulating material 9a, a guide notch may be formed on a portion facing the opening of the other end side of the through hole 19a, and the air introduced from the through hole 19a may be guided into the heat treatment chamber 6 by the notch.

In addition, in the heat treatment device 1, a plurality of heater chamber gas introduction portions 20 through which the burnout air (gas) is introduced into the heater chamber 7 are provided on the lower end portion of the side wall portion 2. Each of the heater chamber gas introduction portions 20 is configured of a notch 20a which is formed on the side part heat insulating material 12 in the heater chamber 7, a pipe 20b which is attached so as to penetrate the side wall portion 2 and communicates with the inner portion of the notch 20a, and an air source 20c (gas source) which supplies air (gas) into the notch 20a via the pipe 20b.

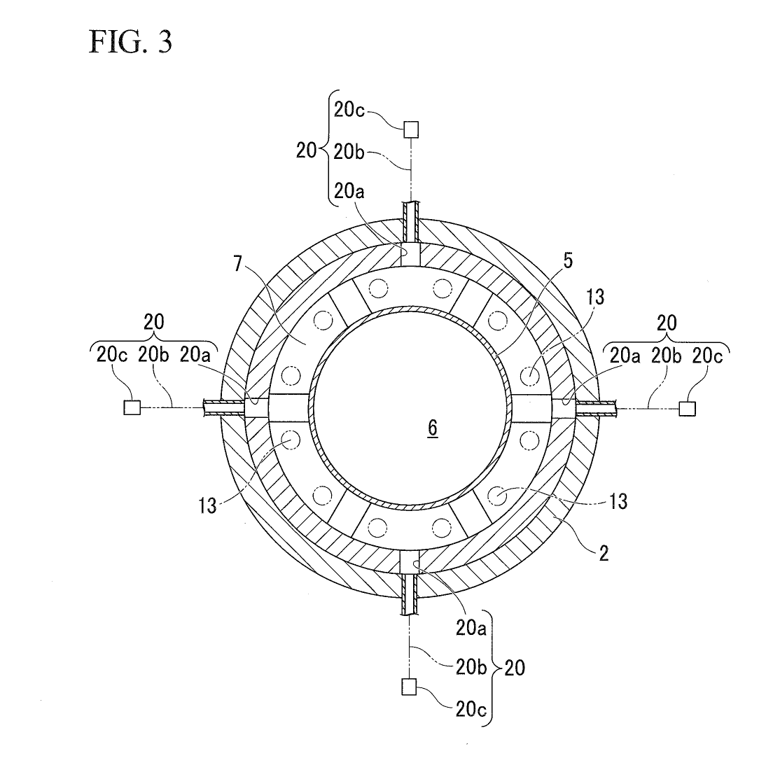

The notch 20a is formed by notching the lower end portion of the side part heat insulating material 12 in a groove shape, and as shown in FIG. 3 which is a view taken along line B-B of FIG. 1, one end side of the notch 20a is directed to the inner surface side of the side wall portion 2, and the other end side thereof communicates with the inner portion of the heater chamber 7. The notches 20a are radially formed at four locations (a plurality of locations) with respect to the heat chamber 7 having an annular shape in a plan view which is formed outside the partition wall 5. In addition, the notches 20a are formed at equal intervals in the circumferential direction of the side part heat insulating material 12.

The pipe 20b is connected to each of the notches 20a, the air source 20c is connected to the pipe 20b, and thus, the heater chamber gas introduction portion 20 is configured. Accordingly, particularly, since the notches 20a are radially formed with respect to the heater chamber 7, four heater chamber gas introduction portions 20 are radially provided with respect to the heater chamber 7. In addition, a control unit (not shown) which adjusts the amount of the supplied air is provided in the air source 20c. Moreover, in this way, since the control unit is provided on each of the air source 20c and the air source 19c, the air source 20c and the air source 19c may be shared with each other, and only the control units which adjust the flow rate may be different from each other in the heat treatment chamber gas introduction portion 19 and the heater chamber gas introduction portion 20.

The air (gas) supplied from the air source 20c is introduced into the heater chamber 7 via the pipe 20b and the notch 20a by the heater chamber gas introduction portion 20 having the above-described configuration. That is, as shown in FIG. 1, the air introduced from the other end side of the notch 20a is introduced into a portion between the side part heat insulating material 12 and the partition wall 5, that is, the heater chamber 7. Here, as shown in FIG. 3, since the other end side of the notch 20a is disposed between the heater 13 and the heater 13 adjacent to each other, the air introduced from the notch 20a reaches the outer surface of the partition wall 5 without being blocked by the heater 13, and thereafter, the air rises in the heater chamber 7.

Moreover, in the heat treatment device 1, a thermocouple (not shown) which measures the temperature inside the heat treatment chamber 6 and a thermocouple (not shown) which measures the temperature inside the heater chamber 7 may be respectively provided. Accordingly, each of the temperature inside the heat treatment chamber 6 and the temperature inside the heater chamber 7 can be independently measured. In addition, particularly, a thermocouple (not shown) for measuring a temperature distribution inside the heat treatment chamber 6 may be also provided. Accordingly, for example, a temperature distribution between the upper portion and the lower portion inside the heat treatment chamber 6, or the like may be measured.

In order to perform carburizing treatment which is heat treatment by the heat treatment device 1, first, the workpiece W is set onto the furnace bottom 9, and is disposed in the heat treatment chamber 6. Subsequently, power is supplied to the heaters 13 so as to heat the heater chamber 7, and the inner portion of the heat treatment chamber 6 which is surrounded by the heater chamber 7 is heated to a desired temperature. In addition, each of the heater chamber 7 and the heat treatment chamber 6 is decompressed via the first exhaust pipe 16 and the second exhaust pipe 11 by operating the vacuum pump.

Moreover, if the heat treatment chamber 6 reaches decompression atmosphere of a desired temperature, the stirring blade 17c is rotated by driving the stirrer 17, and hydrocarbon-based gas is supplied from the gas supply pipe 18. Accordingly, carburizing treatment is performed on the workpiece W. If the carburizing treatment is performed, the hydrocarbon-based gas is decomposed into carbon and hydrogen under a high temperature and a reduced pressure, and polymers may be generated by a polymerization reaction. In addition, the decomposed carbon may turn into soot. However, since the polymer or the soot is generated inside the heat treatment chamber 6 which is surrounded and closed by the partition wall 5 or the like, the polymer or the soot is hardly diffused to the outside of the heat treatment chamber 6, particularly, to the inside of the heater chamber 7.

In this way, if carburizing treatment is performed during a preset time, the supply of the hydrocarbon-based gas stops, and heating performed by the heaters 13 also stops. In addition, the decompression performed by the vacuum pump also stops, and the workpiece W is extracted from the inner portion of the heat treatment chamber 6. Thereafter, a new workpiece W is set to the inner portion of the heat treatment chamber 6, and carburizing treatment can be also performed on the new workpiece W by repeating the above-described operation.

The number of times of carburizing treatment with respect to the workpiece W increases, and if the polymer or the soot is much attached to and accumulated in the inner portion of the heat treatment chamber 6 or the heater chamber 7, burnout is performed. At this time, in the present embodiment, since the heat treatment chamber gas introduction portions 19 through which air is introduced into the heat treatment chamber 6, and the heater chamber gas introduction portions 20 are formed independently from each other, burnout inside the heat treatment chamber 6 and burnout inside the heater chamber 7 can be performed separately to each other.

That is, as described above, compared to a case where the polymer or the soot is generated and accumulated in the heat treatment chamber 6, the accumulation of the polymer or the soot in the heat chamber 7 is relatively small. Accordingly, burnout in the heater chamber 7 may be performed at frequency lower than frequency of burnout inside the heat treatment chamber 6 while it is necessary to perform burnout inside the heat treatment chamber 6 at relatively high frequency.

Accordingly, in the present embodiment, an accumulation state of the soot or the like inside the heat treatment chamber 6 and an accumulation state of the soot or the like inside the heater chamber 7 are separately examined, and in a case where the accumulation of each chamber exceeds a preset reference, burnout of each chamber is performed. For example, in order to perform burnout inside the heat treatment chamber 6, power is supplied to the heaters 13 so as to heat the inner portion of the heat treatment chamber 6 to a preset temperature, and in this state, air is introduced from the heat treatment chamber gas introduction portions 19 into the heat treatment chamber 6 while the stirrer 17 is driven.

Accordingly, as shown by an arrow in FIG. 1, the air introduced through the through holes 19a flows into the heat treatment chamber 6, and the polymer or the soot attached to the inner surface of the partition wall 5, the lower surface of the upper part heat insulating material 10, or the like in the heat treatment chamber 6 is combusted.

In addition, the vacuum pump is operated simultaneously with the introduction of the air or after a predetermined time, and the air in the inner portion of the heat treatment chamber 6 is exhausted via the second exhaust pipe 11. Accordingly, as shown by an arrow in FIG. 1, the combustion gas of the polymer or the soot can be discharged via the second exhaust pipe 11 along with air. By performing the introduction of air or the discharging of the combustion gas for a predetermined time, burnout inside the heat treatment chamber 6 ends.

In addition, burnout inside the heater chamber 7 is also performed approximately similarly to the case of burnout inside the heat treatment chamber 6.

That is, power is supplied to the heaters 13 so as to heat the inner portion of the heater chamber 7 to a preset temperature, and in this state, air is introduced from the heater chamber gas introduction portions 20 into the heater chamber 7. Accordingly, as shown by an arrow in FIG. 1, the air introduced through the notches 20a flows into the heater chamber 7, and the polymer or the soot attached to the outer surface of the partition wall 5, the inner surface of the side part heat insulating material 12, the upper surface of the lower part heat insulating material 8, or the like in the heater chamber 7 is combusted.

In addition, the vacuum pump is operated simultaneously with the introduction of the air or after a predetermined time, and the air in the inner portion of the heater chamber 7 is exhausted via the first exhaust pipe 16. Accordingly, as shown by an arrow in FIG. 1, the combustion gas of the polymer or the soot can be discharged via the first exhaust pipe 16 along with air. By performing the introduction of air or the discharging of the combustion gas for a predetermined time, burnout inside the heater chamber 7 ends.

In addition, burnout inside the heat treatment chamber 6 and burnout inside the heater chamber 7 may be simultaneously performed without being separately performed. That is, by simultaneously performing the introduction of air into the heat treatment chamber 6 through the heat treatment chamber gas introduction portions 19 and the introduction of air into the heater chamber 7 through the heater chamber gas introduction portions 20, it is possible to simultaneously perform burnout inside the heat treatment chamber 6 and burnout inside the heater chamber 7.

According to the heat treatment device 1 of the present embodiment, since the gas introduction portions (heater chamber gas introduction portions 20 and the heat treatment chamber gas introduction portions 19) are independently provided in each of the heater chamber 7 and the heat treatment chamber 6, burnout can be independently performed in each of the heater chamber 7 and the heat treatment chamber 6. Accordingly, it is possible to perform burnout at appropriate timing on each of the heater chamber 7 and the heat treatment chamber 6 in which amounts of attachment or accumulation of the soot or the like are different from each other. That is, burnout can be performed at a relatively high frequency on the heat treatment chamber 6 in which the amount of attachment or accumulation of the soot or the like is large, and burnout can be performed on the heater chamber 7, in which the amount of attachment or accumulation of the soot or the like is relatively small, at frequency lower than the frequency of burnout of the heat treatment chamber 6.

In this way, since it is possible to perform burnout at appropriate timing in each of the heat treatment chamber 6 and the heater chamber 7 and perform burnout under appropriate conditions for each chamber according to the accumulation state of the soot or the like in each chamber, it is possible to perform appropriate burnout on each of the heater chamber 7 and the heat treatment chamber 6. Accordingly, it is possible to stably perform heat treatment (carburizing treatment) of the workpiece W in the heat treatment chamber 6, and it is possible to stabilize treatment quality with respect to the workpiece W.

In addition, the double exhaust pipe which is configured of the first exhaust pipe 16 which communicates with the heater chamber 7 and the second exhaust pipe 11 which communicates with the heat treatment chamber 6 and is inserted into the first exhaust pipe 16 is provided. Accordingly, since the vacuum pump is connected to the double exhaust pipe, the forced exhaust inside the heat treatment chamber 6 and the forced exhaust inside the heater chamber 7 can be simultaneously performed. Therefore, since the exhaust can be performed by one vacuum pump, it is possible to prevent a cost of the device from increasing, and it is possible to decrease the size of the device.

In addition, since the heater chamber 7 is disposed outside the heat treatment chamber 6 so as to surround the heat treatment chamber 6, it is possible to effectively heat the inner portion of the heat treatment chamber 6 by the heaters 13 in the heater chamber 7. Particularly, since the heat treatment chamber 6 is formed in a circular shape in a plan view and the plurality of heaters 13 in the heater chamber 7 are radially disposed with respect to the center of the heat treatment chamber 6, it is possible to uniformly heat the inner portion of the heat treatment chamber 6 by the heaters 13. Accordingly, it is possible to stably perform heat treatment in the heat treatment chamber 6.

Moreover, since the notches 20a are radially formed with respect to the heater chamber 7 and the plurality of the heater chamber gas introduction portions 20 are radially provided with respect to the heater chamber 7, the burnout air can be substantially uniformly introduced into the heater chamber 7. Accordingly, it is possible to more appropriately perform burnout inside the heater chamber 7. Similarly, since the through holes 19a are radially formed with respect to the heat treatment chamber 6 and the plurality of the heat treatment chamber gas introduction portions 19 are radially provided with respect to the heat treatment chamber 6, the burnout air can be substantially uniformly introduced into the heat treatment chamber 6. Accordingly, it is possible to more appropriately perform burnout inside the heat treatment chamber 6.

In addition, the present disclosure is not limited to the above-described embodiment, and various modifications can be applied to the present disclosure within a scope of the present disclosure.

For example, the heat treatment chamber gas introduction portion 19 or the heater chamber gas introduction portion 20 may be appropriately modified according to the size or the like of the heat treatment device.

In addition, in the above-described embodiment, the partition wall and the side wall portion are formed in a cylindrical shape. However, for example, the partition wall (muffle plate) may have a box-shaped structure and the side wall portion may have a box-shaped structure, or the partition wall may have a box-shaped structure and the side wall portion may have a cylindrical shape.

### INDUSTRIAL APPLICABILITY

According to the treatment device of the present disclosure, since the heater chamber and the heat treatment chamber are disposed so as to be adjacent to each other in the heat treatment device, and the gas introduction portion through which the burnout gas is introduced is independently provided in each of the heater chamber and the heat treatment chamber, burnout can be independently performed in each of the heater chamber and the heat treatment chamber. Accordingly, since burnout can be appropriately performed on each chamber, it is possible to stably perform heat treatment on the workpiece, and it is possible to stabilize treatment quality.

What is claimed is:

1. A heat treatment device which performs vacuum carburizing treatment by heating a workpiece, the heat treatment device comprising:
a heater chamber in which a heater is provided;
a heat treatment chamber which is disposed adjacent to the heater chamber and in which the workpiece is heated and vacuum carburizing treatment is performed on the workpiece;
a muffle plate which partitions a portion between the heater chamber and the heat treatment chamber; and
a gas introduction portion through which burnout gas is introduced and which is independently provided in each of the heater chamber and the heat treatment chamber.

2. The heat treatment device according to claim 1,
wherein a double exhaust pipe is provided in the heat treatment device, and the double exhaust pipe includes a first exhaust pipe which communicates with the heater chamber, and a second exhaust pipe which communicates with the heat treatment chamber and is inserted into the first exhaust pipe.

3. The heat treatment device according to claim 1,
wherein the heater chamber is disposed outside the heat treatment chamber and surrounds the heat treatment chamber.

4. The heat treatment device according to claim 2,
wherein the heater chamber is disposed outside the heat treatment chamber and surrounds the heat treatment chamber.

5. The heat treatment device according to claim 3,
wherein the heat treatment chamber is formed in a circular shape in a plan view, and a plurality of the heaters are radially disposed in the heater chamber with respect to the center of the heat treatment chamber.

6. The heat treatment device according to claim 4,
wherein the heat treatment chamber is formed in a circular shape in a plan view, and a plurality of the heaters are radially disposed in the heater chamber with respect to the center of the heat treatment chamber.

7. The heat treatment device according to claim 3,
wherein a plurality of heater chamber gas introduction portions, through which the burnout gas is introduced into the heater chamber, are radially provided with respect to the heater chamber.

8. The heat treatment device according to claim 4, wherein a plurality of heater chamber gas introduction portions, through which the burnout gas is introduced into the heater chamber, are radially provided with respect to the heater chamber.

9. The heat treatment device according to claim 5,
wherein a plurality of heater chamber gas introduction portions, through which the burnout gas is introduced into the heater chamber, are radially provided with respect to the heater chamber.

10. The heat treatment device according to claim 6,
wherein a plurality of heater chamber gas introduction portions, through which the burnout gas is introduced into the heater chamber, are radially provided with respect to the heater chamber.
